(19) United States
(12) Patent Application Publication
(10) Pub. No.: US 2011/0309767 A1
(43) Pub. Date: Dec. 22, 2011

(54) LIGHT-EMITTING ELEMENT DRIVE DEVICE

(75) Inventor: Kazunori OSHIMA, Tokyo (JP)

(73) Assignee: TDK-Lambda Corporation

(21) Appl. No.: 13/162,086

(22) Filed: Jun. 16, 2011

(30) Foreign Application Priority Data
Jun. 16, 2010 (JP) 2010-137736

(51) Int. Cl. H05B 37/02

(52) U.S. Cl. 315/287

(57) ABSTRACT

A light-emitting element drive device capable of expanding a dimming range of a light-emitting element, enabling a constant minimum dimmed luminance to be obtained irrespective of individual differences between devices. A burst signal generating circuit 12 generates a burst signal Vburst which is a PWM dimming signal generated based on a dimming analogue voltage Vbr indicating a dimming level. This circuit 12 includes an oscillating circuit 24 for generating a triangle wave signal Tri ref, a differentiating circuit 28 for detecting a peak of the triangle wave signal Tri ref, the one-shot timer 30 for generating a signal S2 having pulse width of the duration τ (tau), starting point of which is a peak of the triangle wave signal Tri ref, corresponding to the minimum dimmed luminance of the LED 10, and a NAND circuit 32 for generating the burst signal Vburst based on the comparative result between the voltage level at the triangle wave signal Tri ref and the analogue voltage Vbr when the analogue voltage Vbr does not exceed a predetermined voltage or the burst signal Vburst having pulse width of the duration τ (tau) based on the signal S2 when the analogue voltage Vbr exceeds a predetermined voltage.

### CROSS REFERENCE TO RELATED APPLICATIONS

This application claims the benefit of Japanese Patent Application Serial No. 2010-137736, entitled “LIGHT-EMITTING ELEMENT DRIVE DEVICE”, filed Jun. 16, 2010, which is herein incorporated by reference in its entirety.

### BACKGROUND OF THE INVENTION

1. Field of the Invention

The present invention relates to a light-emitting element drive device applicable to an LED (light-emitting diode) illuminating device, an image display device and the like, particularly to a light-emitting element drive device for performing the dimming control of a light-emitting element, using an external dimming signal.

2. Description of the Related Art

In Japanese patent application publication No. 2009-167173, for example, there is disclosed an LED drive device for performing the dimming control of an LED, i.e., a load acting as a light-emitting element, using an analogue voltage inputted from external, as a dimming control signal. The dimming control circuit disclosed herein performs PWM (Pulse Width Modulation) control using a burst signal Vburst for burst dimming (PWM dimming) to the LED, as shown in FIG. 6. The burst signal Vburst is a pulse signal and is generated based on a result of comparison between the analogue voltage Vbr of the dimming signal and a triangle wave signal Tri ref generated from an internal signal generator.

According to the conventional art, when the analogue voltage Vbr of the dimming signal is increased to reach the vicinity of a higher peak voltage of the triangle wave signal Tri ref (refer to a voltage Va in FIG. 6) in order to reduce an amount of light of an LED using the dimming control, the light of the LED sometimes flickers, or performance of a display device incorporating the LED drive device is sometimes interfered by interference between the LED drive device and the display devices. This is attributable to the fact that changes in power supply voltage, noises and etc. cause the analogue voltage Vbr and the triangle wave signal Tri ref to fluctuate and thus a PWM duty cycle (duty ratio) and a PWM frequency of the burst signal Vburst are unstably changed. Particularly, the closer the analogue voltage Vbr comes to a higher peak voltage of the triangle wave signal Tri ref (the more an amount of light of the LED is reduced), the more susceptible to such changes (changes in the analogue voltage Vbr and the triangle wave signal Tri ref) the PWM duty cycle and the PWM frequency of the burst signal Vburst becomes.

Also, variations in properties of parts employed in the LED drive devices also affect the dimming signal and the triangle wave signal Tri ref and hence such signals in the LED drive devices vary. If a minimum dimmed luminance is desired in each of the LED drive devices, adjustments for individual devices are required.

In order to avoid the problem described above, according to one of conventional arts, the uppermost level of the analogue voltage Vbr to be compared with the triangle wave signal Tri ref is limited so that the duty cycle of the burst signal Vburst becomes not less than 5%. If such technique is employed, however, there arises a problem that the dimming range of an LED becomes narrow.

### SUMMARY OF THE INVENTION

Therefore, with the view of the problem described above, it is an object of the present invention to provide a light-emitting element drive device capable of expanding a dimming range of a light-emitting element and then obtaining the same minimum dimmed luminance in all devices independently of characteristic variations between individual devices.

In order to attain the object described above, the light-emitting element drive device according to the present invention comprises a burst signal generating circuit for generating a burst signal which is a PWM dimming signal generated based on a dimming analogue voltage indicating a dimming level, wherein the burst signal generating circuit includes: a reference signal generating circuit for generating a reference signal with a peak appearing periodically, a peak detecting circuit for detecting a peak of the reference signal, a minimum dimming signal generating circuit for generating a minimum dimming signal, generated responsive to peak detecting in the peak detecting circuit, having pulse width corresponding to a minimum dimmed luminance of the light-emitting element, a dimming signal generating circuit for generating a dimming signal based on the analogue voltage and the reference signal, and an output circuit for outputting the dimming signal as the burst signal when the analogue voltage does not exceed a predetermined value, and outputting the minimum dimming signal as the burst signal when the analogue voltage exceeds the predetermined value.

Also, the minimum dimming signal generating circuit may preferably comprise a microcomputer.

Also, the dimming signal generating circuit may preferably further comprise a comparator for outputting a result of comparison between the reference signal and the analogue voltage.

Also, the minimum dimming signal generating circuit may preferably have an open-collector or open-drain output, and the dimming signal generating circuit may preferably have an open-collector or open-drain output, and the output circuit may preferably output the burst signal using the open-collector or open-drain output of the minimum dimming signal generating circuit and the open-collector or open-drain output of the dimming signal generating circuit.

Also, the peak detecting circuit may preferably comprise a differentiating circuit for detecting a peak of the reference signal by differentiating the reference signal.

Also, the minimum dimming signal generating circuit may preferably comprise a charging circuit for charging and recharging a capacitor.

Further, the reference signal may preferably be switched between ascending and descending periodically.

According to the present invention, generation of the on time signal with a certain duration, the starting point of which is a peak of the reference signal, is initiated in the minimum dimming signal generating circuit per every cycle of the reference signal. Hence, when the dimming analogue voltage has exceeded the voltage level at the initiating point, the output circuit generates the burst signal having pulse width of the duration based on the on time signal, thus making it possible to allow the light-emitting element to become luminous at the minimum dimmed luminance according to the duty cycle of this burst signal. Consequently, the need for limiting the analogue voltage level in view of variations between individual light-emitting drive devices is eliminated to enable the dimming range of the light-emitting element to be expanded. And besides, regardless of any variations between individual light-emitting element drive devices, the minimum dimmed luminance can be obtained uniquely for the light-emitting element.

Also, when the minimum dimming signal generating circuit is made up using a microcomputer, the duration of the on time signal, eventually the minimum dimmed luminance, etc, can be easily varied by updating and rewriting a program stored in the microcomputer.

Further, when the dimming analogue voltage has not yet increased to reach the vicinity of a higher peak voltage of the reference signal, a dimming control can be performed using the result of comparison to the light-emitting element.

Furthermore, there can be configured the output circuit without regard to value of the minimum dimming signal voltage and value of the dimming signal voltage.

Still further, the peak detecting circuit can detect a periodically appearing peak of the reference signal from the reference signal generating circuit to output a detected signal.

Additionally, charging operation of the capacitor can start synchronously with the falling edge of the reference signal and the charging time of the capacitor corresponds to the duration.

In addition, the minimum dimming signal generating circuit can generate an minimum dimming signal every time the recurringly increasing and decreasing voltage level of the reference signal turns from ascending to descending, so that the burst signal can be generated every time when the analogue voltage has exceeded the predetermined value to allow the light-emitting element to become luminous at the minimum dimmed luminance.

### BRIEF DESCRIPTION OF THE DRAWINGS

These objects and other objects and advantages of the present invention will become more apparent upon reading of the following detailed description and the accompanying drawings in which:

FIG. 1 is a circuit diagram illustrating a configuration of a light-emitting element drive device according to one embodiment of the present invention.

FIG. 2 is a circuit diagram illustrating a burst signal generating unit shown in FIG. 1 according to the embodiment of the present invention.

FIG. 3 is a waveform chart illustrating a voltage in respective parts according to the embodiment of the present invention.

FIG. 4 is a graph showing a relationship between the duty ratio of a burst signal and the analogue voltage of a dimming signal with respect to a product according to the present embodiment and those according to conventional arts.

FIG. 5 is a flow chart illustrating processing procedures in the case of using a microcomputer for realizing the differentiating circuit and the one-shot timer, according to a modified embodiment of the invention.

FIG. 6 is a waveform diagram illustrating a voltage in respective parts according to a related art.

### DETAILED DESCRIPTION OF THE PREFERRED EMBODIMENT

Hereunder is a description of a preferred embodiment of the present invention with reference to the accompanying drawings.

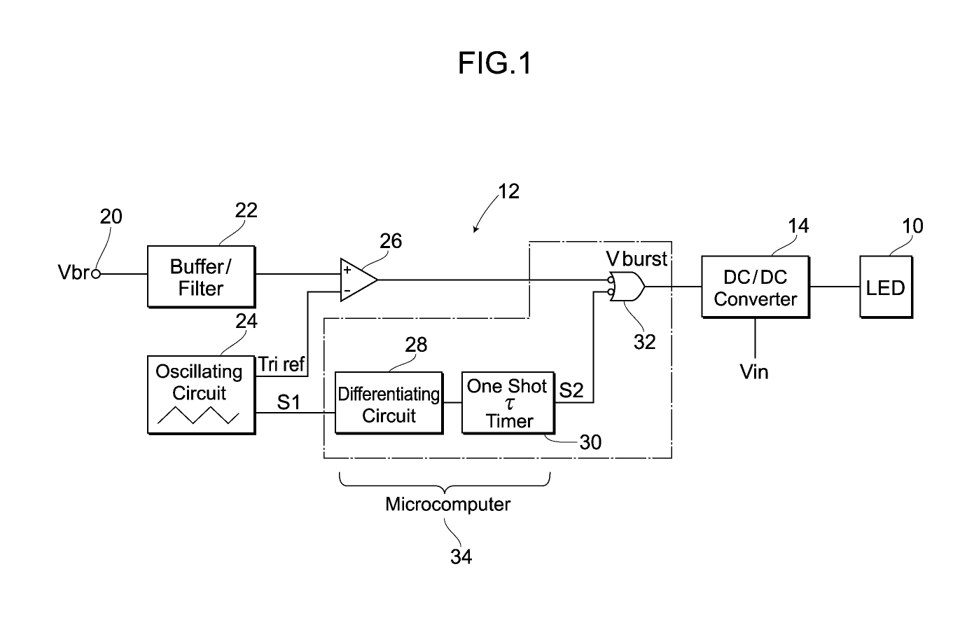

FIG. 1 shows an overall configuration of a light-emitting element drive device according to one embodiment of the present invention. In FIG. 1, the light-emitting element drive device according to the present embodiment comprises a burst signal generating circuit 12 for generating a burst signal Vburst which is a PWM signal modified based on an analogue voltage Vbr and is used for burst dimming (PWM dimming) to an LED 10, as a load, and a DC/DC converter 14 for converting an input voltage Vin into a output voltage Vout which is pulsed based on this burst signal and is applied as a pulse voltage to the LED 10. The burst signal generating circuit 12 comprises an input terminal 20 to which an analogue voltage Vbr of the dimming signal is applied from the outside of the device, a buffer/filter 22 connected with the input terminal 20 to be utilized for impedance conversion and noise removal, an oscillating circuit 24 for outputting the triangle wave signal Tri ref with a constant amplitude and a constant period, and a comparator 26 for outputting a comparative result between the analogue voltage Vbr and the triangle wave signal Tri ref. A conventional burst signal generating circuit comprises the foregoing components. The burst signal generating circuit 12 according to the present embodiment further comprises, in addition to the foregoing components, those shown inside a section surrounded by a dashed-dotted line in FIG. 1, i.e., a differentiating circuit 28 for detecting a peak of the triangle wave signal Tri ref based on a signal S1 from the oscillating circuit 24 to output a detected signal, a one-shot timer 30 acting as a timer circuit for generating a signal S2 with a certain duration τ (tau) responsive to the detected signal from the differentiating circuit 28, and a NAND circuit 32 to which an output signal from the comparator 26 and the signal S2 from the one-shot timer 30 are input, respectively.

According to the foregoing configuration, the DC/DC converter 14 is provided so as to act as a converter circuit for supplying constant-current to one or more LEDs 10. Alternatively, an AC/DC converter may be used, instead of the DC/DC converter 14, when a power source is an AC power, and hence a power supply circuit supplying power to LED 10 is not limited to the DC/DC converter 14. The point is to enable the dimming control of the LEDs 10 using the burst signal Vburst from the burst signal generating circuit 12. Although the oscillating circuit 24 employed in the present embodiment generates the triangle wave signal Tri ref, an oscillating circuit for generating a saw-tooth wave signal instead of the oscillating circuit 24 may be employed. Alternatively, an oscillating circuit for generating signal having any waveforms may be employed as long as a pulse signal with a duty cycle (duty ratio) according to a voltage level of the analogue voltage Vbr is output through the comparator 26 and besides the differentiating circuit 28 can detect a peak of the signal.

In addition, the NAND circuit 32 acting as the output circuit may be modified variously, e.g., into a different logical circuit such as an OR circuit. The logical circuit is modified based on whether the output signal from the comparator 26 and the signal S2 from the one-shot timer 30 are positive logic or negative logic. The output circuit employed in the present embodiment may have the functions to generate the burst signal Vburst input to the DC/DC converter 14 based on the output signal from the comparator 26 when the on-duration of the output signal from the comparator 26 is longer than the duration τ (tau) of the signal S2 generated in the one-shot timer 30 (when a duty cycle of the output signal from the comparator 26 is larger than a duty cycle of the signal S2 generated in the one-shot timer 30), and based on the signal S2 from the one-shot timer 30 when the on-duration thereof is shorter the duration τ (tau) (when a duty cycle of the output signal from the comparator 26 is smaller than a duty cycle of the signal S2 generated in the one-shot timer 30).

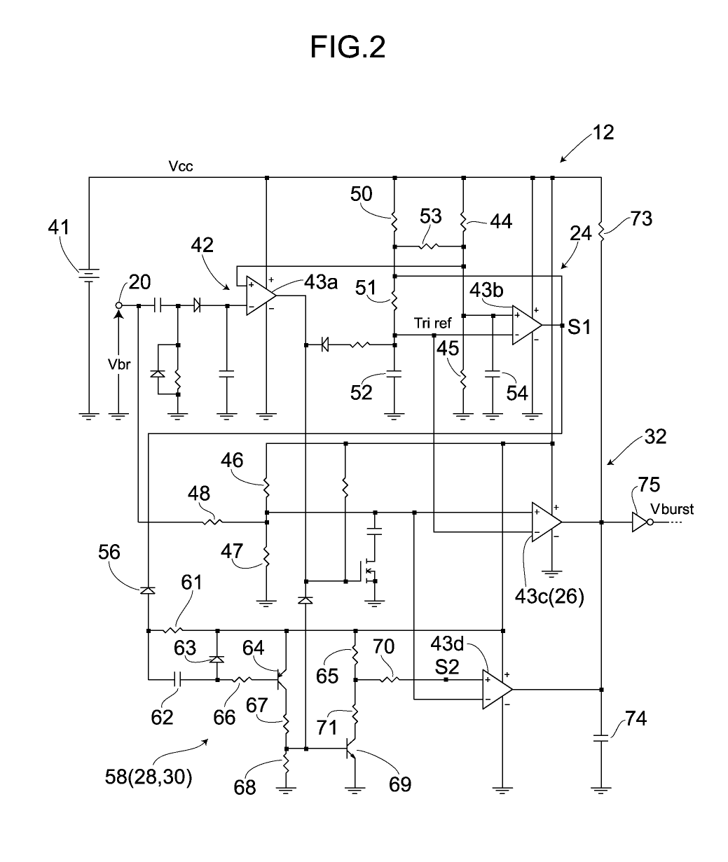

FIG. 2 shows an example of a more detailed circuit configuration of the burst signal generating circuit 12 shown in FIG. 1. In FIG. 2, numeral symbol 41 denotes a direct-current power source for supplying the operating voltage Vcc to each part of the burst signal generating circuit 12. Numeral symbol 42 denotes a signal discriminating circuit for discriminating the kind of the dimming signal applied to the input terminal 20. The signal discriminating circuit determines whether the dimming signal is pulsed or not pulsed. Voltage-dividing resistors 44, 45 and voltage-dividing resistors 46, 47 in addition to four comparators 43a, 43b, 43c and 43d are connected between the operating voltage Vcc line and the ground line. Here, the comparator 43a makes up a part of the signal discriminating circuit 42. Other circuit configuration of the signal discriminating circuit 42, however, has no direct relation to the subject matter of the present invention and hence the detailed description thereof is omitted.

One end of a resistor 48 is connected with the input terminal 20, while the other end of the resistor 48, together with a connecting point of the voltage-dividing resistors 46, 47, is connected with a noninverting input terminal of the comparator 43c and an inverting input terminal of the comparator 43d. Accordingly, when a direct-current dimming signal is applied to the input terminal 20, the analogue voltage Vbr of the dimming signal is applied to input terminals of the comparators 43c, 43d via the resistor 48, respectively. The comparator 43c corresponds to the comparator 26 acting as a comparing circuit shown in FIG. 1. The triangle wave signal Tri ref is supplied from the oscillating circuit 24 to the inverting input terminal of the comparator 26.

The oscillating circuit 24 employed in the present embodiment is equipped with, in addition to the comparator 43b and the voltage-dividing resistors 44, 45, a series circuit of resistors 50, 51 and capacitor 52 which are connected between the operating voltage Vcc line and the ground line, a resistor 53 connected between a connecting point of the resistors 50, 51 and a connecting point of the dividing resistors 44, 45, and a capacitor 54 connected across the resistor 45. The connecting point of the dividing resistor 44, 45 is connected with a noninverting input terminal of the comparator 43b, while a connecting point of the resistor 51 and the capacitor 52 is connected with an inverting input terminal of the comparator 43b, and further the output terminal of the comparator 43b is connected with the connecting point of the resistors 50, 51.

Then, in the oscillating circuit 24, when the voltage level across the capacitor 52 exceeds that of the connecting point of the dividing resistors 44, 45 due to the capacitor 52 for generating a triangle wave being charged, an signal S1 output from the comparator 43b switches to an L (low) level and thus a voltage level at the connecting point of the resistors 50, 51 goes down, discharging operation of the capacitor 52 starts, and besides, a voltage level at the connecting point of the dividing resistors 44, 45 also goes down because the connecting point of the dividing resistors 44, 45 is coupled with he connecting point of the resistors 50, 51via the resistor 53. Thereafter, when the voltage level across the capacitor 52 becomes lower than the voltage level at the connecting point of the dividing resistors 44, 45 due to the discharge of the capacitor 52, the signal S1 output from the comparator 43b then switches to an H (high) level and thus the voltage level at the connecting point of the resistors 50, 51 rises, charging operation of the capacitor 52 starts and besides the voltage level at the connecting point of the dividing resistors 44, 45 rises because the connecting point of the dividing resistors 44, 45 is coupled with he connecting point of the resistors 50, 51 via the resistor 53. The operation thus performed is repeated and thus a voltage generated by the charging and discharging operations of the capacitor 52 are outputted as the triangle wave signal Tri ref in the oscillating circuit 24. Further, when the voltage level of the signal S1 switches from the H level to the L level, a voltage of the triangle wave signal Tri ref reach a peak is output to a minimum dimming signal generating circuit 58 via the diode 56.

The minimum dimming signal generating circuit 58 acts as both the foregoing differentiating circuit 28 and the one-shot timer 30. The minimum dimming signal generating circuit 58 is configured as follows: one terminals of a resistor 61 and a capacitor 62 are each connected with the output terminal of the comparator 43b via the diode 56; the cathode of a diode 63, the emitter of a PNP transistor 64 and one terminal of a resistor 65 are connected with the other terminal of the resistor 61 connected with the operating voltage Vcc line; the other terminal of the capacitor 62 and an anode of the diode 63 are connected with one terminal of a resistor 66; the other terminal of the resistor 66 is connected with the base of the transistor 64; a series circuit of resistors 67, 68 is connected between the collector of the transistor 64 and the ground line; a connecting point of the resistors 67, 68 is connected with the base of a NPN transistor 69 whose emitter is grounded; one terminals of resistors 70, 71 are connected with the other terminal of the resistor 65; and the other terminal of the resistor 71 is connected with the collector of the transistor 69.

Among these elements, both the transistors 64, 69 correspond to the buffer of the on time signal generating circuit 58. Instead of the bipolar transistors, however, a switch element such as MOSFETs or the like may be used. For the purpose of detecting the falling edge of the signal S1, this minimum dimming signal generating circuit 58 differentiates the signal Si with the capacitor 62 and the resistors 66 to output the signal S2 from the other terminal of the resistor 70 to the noninverting input terminal of the comparator 43d. Charging operation of the capacitor 62 starts synchronously with the falling edge of the signal S land the charging time of the capacitor 62 corresponds to the duration τ (tau).

In the foregoing on the minimum dimming signal generating circuit 58, when the voltage level at the triangle wave signal Tri ref generated in the oscillating circuit 24 reaches the peak and thus the voltage level at the signal Si switches from H to L, a charging current flowing into the capacitor 62 starts and thus both the transistors 64, 69 turn on to lower the voltage level at the connecting point of the resistors 65, 71, eventually the voltage level at the noninverting input terminal of the comparator 43d. Thereafter, when the duration τ (tau) has passed, the capacitor 62 is full charged and the charging current flowing into the capacitor 62 stops. As a result, both the transistors 64, 69 turn off and the voltage level at the noninverting input terminal of the comparator 43d rises. Accordingly, here, every time the voltage level at the triangle wave signal Tri ref reaches the peak, the signal S2 with L level of the duration τ (tau) is supplied from the oscillating circuit 24 to the input terminal of the comparator 43d making up the NAND circuit 32.

The NAND circuit 32 comprises a pull-up resistor 73, a noise eliminating capacitor 74, and an inverter 75, in addition to the comparators 43c, 43d with an open-collector or open-drain output. Further, in the NAND circuit 32, the output terminals of the comparators 43c, 43d are connected with each other; the resistor 73 is connected between the connecting point of the output terminals of the comparators 43c, 43d and the operating voltage Vcc line; and the capacitor 74 is connected between the ground line and the resistor 73 (the connecting point of the output terminals of the comparators 43c, 43d). Then, the voltage level generated at the connecting point of the output terminals of the comparators 43c, 43d is inverted by the inverter 75 to output the inverted voltage as the burst signal Vburst output to the DC/DC converter 14.

Then, when the analogue voltage Vbr of the dimming signal is higher than a voltage of the triangle wave signal Tri ref, the comparator 43c switches its output terminal to an open state (a high impedance state), whereas when the analogue voltage Vbr is lower than the voltage of the triangle wave signal Tri ref, the comparator 43c switches a voltage level of its output terminal to L level. Further, when the signal S2 obtained in the minimum dimming signal generating circuit 58 is higher than the analogue voltage Vbr of the dimming signal, the comparator 43d switches its output terminal to an open state (a high impedance state), whereas when the signal S2 is lower than the analogue voltage Vbr, the comparator 43d switches a voltage level of its output terminal to L level. When at least one of the comparators 43c, 43d output L level, the inverter 75 outputs an H level as burst signal Vburst, while when the output terminals of both the comparators 43c, 43d are in the open state (a high impedance state), the inverter 75 outputs L level as burst signal Vburst.

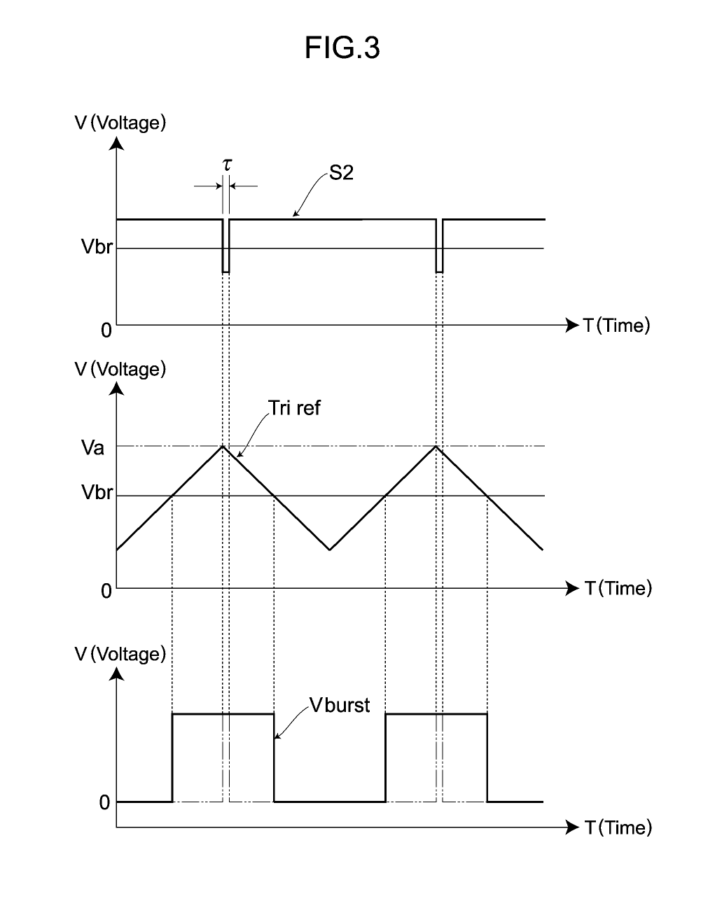

Next is a description of the behavior of the foregoing configuration with reference to the waveform charts shown in FIG. 3. Note that in FIG. 3, for descriptive purpose, a voltage waveform part corresponding to the signal S2 is shown above the triangle wave signal Tri ref as shown in the upper space. The composite signal is shown together with the analogue voltage Vbr of the dimming signal. The burst signal Vburst is shown in the lower space. The burst signal Vburst is obtained as a comparative result between the composite signal and the analogue voltage Vbr of the dimming signal. As described below, however, the triangle wave Tri ref and the on time signal S2 are separately generated.

The analogue voltage Vbr of the dimming signal is applied to the burst signal generating circuit 12 via the input terminal 20. This analogue voltage Vbr is applied to inverting input terminal of the comparator 43c via the buffer/filter 22 to be compared with the triangle wave signal Tri ref generated in the oscillating circuit 24. When the analogue voltage Vbr is higher than the voltage level at the triangle wave signal Tri ref, the output terminal of the comparator 43c switches to an open state, whereas when the analogue voltage Vbr is lower than the voltage level at the triangle wave signal Tri ref, the output terminal of the comparator 43c switches to L level.

The oscillating circuit 24 outputs the signal S1 to the minimum dimming signal generating circuit 58 in which the voltage level at the signal S1 is switched from L level to H level synchronously with a peak of the triangle wave signal Tri ref. At the peak, the triangle wave signal Tri ref changes from ascending to descending and at the same time, the voltage level at the signal S1 is switched from H level to L level. By taking advantage of the operation in which the voltage level at the signal S1 is switched from H level to L level, the minimum dimming signal generating circuit 58 charges the capacitor 62 for a given length of time to output the signal S2 with a low voltage of the duration τ (tau) (the signal S2 dropping for the duration τ (tau)) to the comparator 43d. The comparator 43d compares the analogue voltage Vbr and the signal S2. When the S2 becomes lower than the analogue voltage Vbr, the comparator 43d switches a voltage level of its output terminal to L level, whereas when the S2 becomes higher than the analogue voltage Vbr, the comparator 43d switches its output terminal to an open state.

The comparators 43c, 43d make up part of the NAND circuit 32. Then, when the analogue voltage Vbr is lower than a neighbor point of a peak of the triangle wave signal Tri ref (precisely, indicating an intersecting point of the triangle wave signal Tri ref with the signal S2 as shown in FIG. 3), the burst signal Vburst with a duty cycle depending on the comparative result between the analogue signal Vbr and the triangle wave signal Tri ref is output from the NAND circuit 32 to the DC/DC converter 14. At the same time when the analogue voltage Vbr becomes higher than the neighbor point of the peak of the triangle wave Tri ref, the duty cycle of the burst signal Vburst output from the NAND circuit 32 to the DC/DC converter 14 is fixed at the minimum duty cycle corresponding to the minimum duration τ (tau). Based on the burst signal Vburst from the burst signal generating circuit 12, the DC/DC converter 14 applies an output voltage Vout to the LED 10 at time intervals according to the duty cycle of this burst signal Vburst(the DC/DC converter 14 applies an output voltage Vout pulsed according to the duty cycle of this burst signal Vburst to the LED 10), regulating the luminance of the LED 10.

Specifically, by taking advantage of the peak of the triangle wave signal Tri ref, the minimum dimming signal generating circuit 58 proposed here provides the signal S2 whose voltage drops for a certain duration τ (tau) which starts from the peak. By using the minimum dimming signal generating circuit 58, the burst signal Vburst with the minimum duration τ (tau) for dimming without being susceptible to changes in power-supply voltage (the input voltage Vin) and noises is generated. As a result, when the analogue voltage Vbr becomes higher than a voltage of the neighbor point of the peak of the triangle wave signal Tri ref, the burst signal Vburst having pulse width corresponding to the duration τ (tau) is supplied to the DC/DC converter 14 and the LED 10 becomes luminous at the constant minimum dimmed luminance. Besides, the duty cycle of the burst signal Vburst at this time is fixed at the minimum duty cycle corresponding to the minimum duration τ (tau) for dimming and its period is unvaried to be kept constant. Hence, even if the luminescence of the LED 10 is reduced to a lower level, such defects that the light of the LED 10 flickers and the interference occurs to a display unit incorporating the burst signal generating circuit 12 can be swept away.

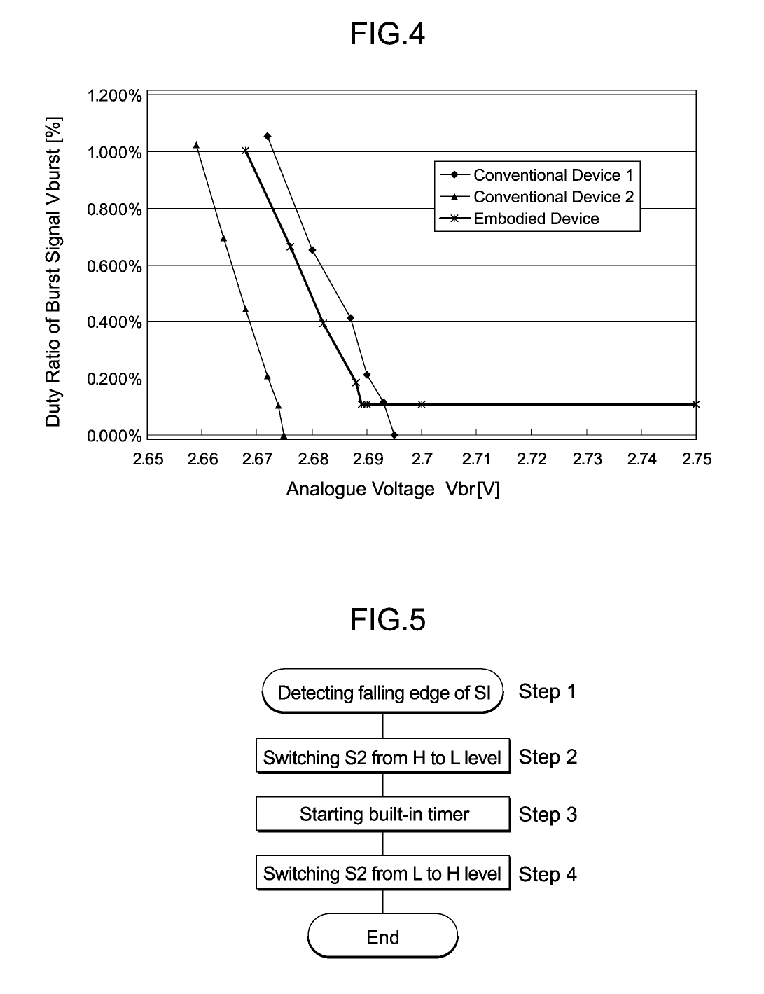

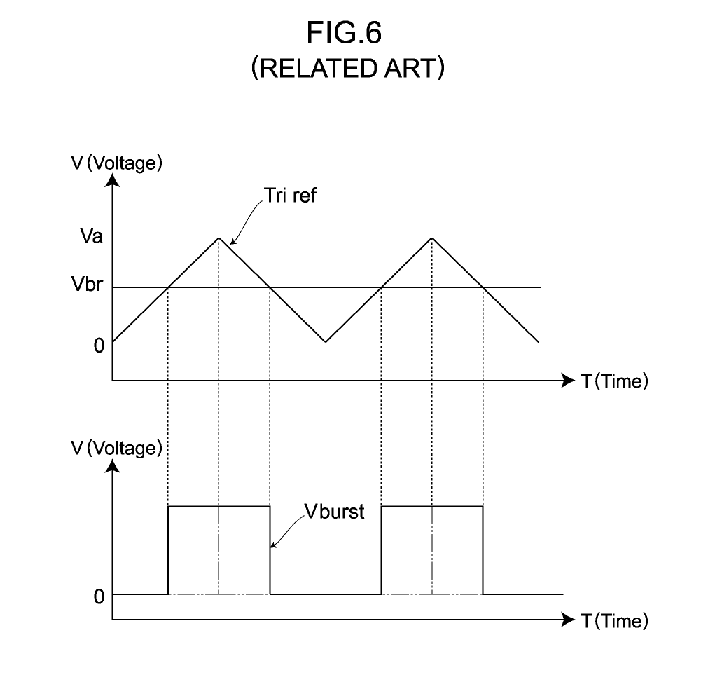

FIG. 4 is a graph showing the actual effect in the present embodiment. Here, there is shown a relationship between the duty cycle of the burst signal Vburst and the analogue voltage Vbr of the dimming signal in conventional devices (two devices) and the device embodied based on the foregoing configuration.

When extracting three samples including the conventional devices 1, 2 and one device according to the present embodiment, the analogue voltage Vbr of the dimming signal at which the duty cycle of the burst signal Vburst is 0.2% is 2.672 to 2.69V in the conventional devices, exhibiting a variation between individual devices. Specifically, even if the minimum duty cycle of the burst signal Vburst is determined as 0.2%, when the luminance of the LED 10 is required to be set at a minimum value for dimming, in the conventional devices 1, 2, an analogue voltage Vbr corresponding to each of the devices 1, 2 is not uniquely determined, leading to the difficulty of uniquely setting the minimum dimmed luminance irrespective of the individual difference between the devices.

In the present embodiment, however, when the analogue voltage Vbr of the dimming signal is allowed to go on rising, pulse width of the burst signal Vburst is clamped by the minimum duration τ (tau) which is determined by the minimum dimming signal generating circuit 58 built in the device, thereby making it easy to uniquely set the minimum dimmed luminance of the LED 10 irrespective of the individual difference between the devices. Incidentally, in an example shown in FIG. 4, when the analogue voltage Vbr is set at 2.7V or more, no effect due to the individual difference occurs, thus permitting the LED 10 to be uniquely set at the minimum dimmed luminance.

According to the present embodiment as described above, the light-emitting element drive device is equipped with the burst signal generating circuit 12 for generating the burst signal Vburst based on the dimming analogue voltage Vbr applied to the input terminal 20 and then to allow a dimming control of the LED 10 acting as a light-emitting element to be performed, which dimming control is PWM dimming control using this burst signal Vburst. This burst signal generating circuit 12 comprises the oscillating circuit 24 for generating a reference signal as a triangle wave signal Tri ref, a saw-tooth wave signal or the like, that have peaks; the minimum dimming signal generating circuit 58 for generating the signal S2 having pulse width of the duration τ (tau), whose starting point is a peak of the reference signal, corresponding to the minimum dimmed luminance of the LED 10; and the NAND circuit 32 acting as a output circuit for generating the burst signal based on the comparative result between the voltage level at the reference signal and the analogue voltage Vbr or the burst signal having pulse width of the duration τ (tau) based on the signal S2. The burst signal having pulse width of the duration τ (tau) is outputted when the analogue voltage Vbr exceeds a predetermined voltage.

According to such a scheme, generation of the on time signal S2 with a certain duration τ (tau), whose starting point is a peak of the reference signal, is initiated in the minimum dimming signal generating circuit 58 per every cycle of the reference signal. Hence, when the dimming analogue voltage Vbr has exceeded the voltage level at the initiating point, the NAND circuit 32 generates the burst signal Vburst having pulse width of the duration τ (tau) based on the signal S2, thus making it possible to allow the LED 10 to become luminous at the minimum dimmed luminance according to the duty cycle of this burst signal Vburst. Consequently, the need for limiting the analogue voltage level in view of variations between individual light-emitting drive devices is eliminated to enable the dimming range of the LED 10 to be expanded. And besides, regardless of any variations between individual light-emitting element drive devices, the minimum dimmed luminance can be obtained uniquely for the LED 10.

Besides, as a modified example, part of the function of the burst signal generating circuit 12 shown in FIG. 1 can be realized by means of a microcomputer 34 or the like. FIG. 5 shows a processing flowchart of a program stored in a storage section of a microcomputer 34. The microcomputer mentioned here has the function of generating the signal S2 based on the signal S1 from the oscillating circuit 24 according to the processing procedure of the program shown in FIG. 5.

In the processing flowchart shown in FIG. 5, first, a falling edge of the signal S1 is detected at step 1. When the voltage level at the signal S1 switches from an H level to an L level, a voltage level at the signal S2 is switched from an H level to an L level at step 2. At the same time, a built-in timer starts at step 3. when a certain duration τ (tau) has elapsed, the voltage level at the signal S2 is switched from an L level to an H level at step 4. Thus, every time the voltage level at the triangle Tri ref reaches its peak where a voltage level of the triangle Tri ref turns from uprising (ascending) to descending, the signal S2 for obtaining a signal having pulse width of the duration τ (tau) corresponding to the minimum dimmed luminance of the LED 10 is generated in the microcomputer 34 and is output to the NAND circuit at the subsequent stage. Other behaviors and other effects are entirely equivalent to the above embodiment, thus omitting its description.

In this manner, the minimum dimming signal generating circuit 58 making up at least part of the function of the burst signal generating circuit 12 is made up using the microcomputer 34, thereby the duration τ (tau) relating to the signal S2, eventually the minimum dimmed luminance or the like can be easily varied by updating and rewriting a program stored in the microcomputer 34.

Besides, according to the present embodiment, the burst signal generating circuit 12 comprises the comparator 26 for outputting result of comparison between the triangle wave signal Tri ref and the analogue voltage Vbr.

Also, according to the present embodiment, the one-shot timer 30 has the comparator 43d with an open-collector or open-drain output, and the conventional burst signal generating circuit is configured to have the comparator 26(43c) with an open-collector or open-drain output, and the NAND circuit 32 outputs the burst signal Vburst using the comparator 43d and the comparator 26(43c). Hence, there can be configured the NAND circuit 32 without regard to value of the signal S2 voltage and value of the result of comparison between the triangle wave signal Tri ref and the analogue voltage Vbr.

Also, according to the present embodiment, the differentiating circuit 28 can detect a periodically appearing peak of the reference signal from the oscillating circuit 24 to output a detected signal.

Also, according to the present embodiment, charging operation of the capacitor 62 can start synchronously with the falling edge of the reference signal and the charging time of the capacitor 62 corresponds to the duration τ (tau).

Also, according to the present embodiment, the reference signal as a triangle wave signal Tri ref, a saw-tooth wave signal or the like is switched between ascending and descending periodically. Hence, the one-shot timer 30 can generate the signal S2 every time the recurringly increasing and decreasing voltage level of the reference signal turns from ascending to descending, so that the burst signal Vburst can be generated every time when the analogue voltage Vbr has exceeded the predetermined value to allow the LED 10 to become luminous at the minimum dimmed luminance.

In addition, the present invention is not limited to the present embodiment and various modifications are possible within the scope of the gist of the present invention. The polarity of the voltage level of each signal in the present embodiment and the polarity of each of the input terminals of the comparators 43a, 43b, 43c, 43d may be accordingly inverted to obtain the same operations and effects. Further, a specified configuration of the burst signal generating circuit 12 is not limited to those shown in FIG. 1 and FIG. 2.

What is claimed is:

1. A light-emitting element drive device comprising a burst signal generating circuit for generating a burst signal which is a PWM dimming signal generated based on a dimming analogue voltage indicating a dimming level,
wherein said burst signal generating circuit includes:
a reference signal generating circuit for generating a reference signal with a peak appearing periodically;
a peak detecting circuit for detecting a peak of said reference signal;
a minimum dimming signal generating circuit for generating a minimum dimming signal, generated responsive to peak detecting in said peak detecting circuit, having pulse width corresponding to a minimum dimmed luminance of said light-emitting element;
a dimming signal generating circuit for generating a dimming signal based on said analogue voltage and said reference signal, and
an output circuit for outputting said dimming signal as said burst signal when said analogue voltage does not exceed a predetermined value, and outputting said minimum dimming signal as said burst signal when said analogue voltage exceeds said predetermined value.

2. The light-emitting element drive device according to claim 1, wherein said minimum dimming signal generating circuit comprises a microcomputer.

3. The light-emitting element drive device according to claim 1, wherein said dimming signal generating circuit comprises a comparator for outputting a result of comparison between said reference signal and said analogue voltage.

4. The light-emitting element drive device according to claim 1, wherein said minimum dimming signal generating circuit has an open-collector or open-drain output, and
wherein said dimming signal generating circuit has an open-collector or open-drain output, and
wherein said output circuit outputs said burst signal using said open-collector or open-drain output of said minimum dimming signal generating circuit and said open-collector or open-drain output of said dimming signal generating circuit.

5. The light-emitting element drive device according to claim 1, wherein said peak detecting circuit comprises a differentiating circuit for detecting a peak of said reference signal by differentiating said reference signal.

6. The light-emitting element drive device according to claim 1, wherein said minimum dimming signal generating circuit comprises a charging circuit for charging and recharging a capacitor.

7. The light-emitting element drive device according to claim 1, wherein said reference signal is switched between ascending and descending periodically.
